(19) United States
(12) Patent Application Publication
(10) Pub. No.: US 2017/0369079 A1
(43) Pub. Date: Dec. 28, 2017

(54) Bogie For A Railway Vehicle

(71) Applicant: SIEMENS AKTIENGESELLSCHAFT, MUENCHEN (DE)

(72) Inventor: JUERGEN SCHLAHT, FUERTH (DE)

(21) Appl. No.: 15/531,055

(22) PCT Filed: Oct. 30, 2015
(86) PCT No.: PCT/EP2015/075293

§ 371 Date: May 26, 2017

(30) Foreign Application Priority Data
Nov. 26, 2014 (DE) 10 2014 224 148.0

(51) Int. Cl. B61C 9/50; B60L 15/20

(52) U.S. Cl. CPC B61C 9/50; B60L 15/2045

(57) ABSTRACT

A bogie for a railway vehicle has at least two track guide units, in particular at least two wheels sets. A traction motor is arranged in the region of one of the track guide units, hereinafter called the first track guide unit. The traction motor drives the first track guide unit. A power converter supplies power to the traction motor driving the first track guide unit. The power converter is arranged in a region of a different track guide unit, which is not driven, i.e., the second track guide unit.

The invention relates to a bogie for a rail-borne vehicle and also to rail-borne vehicles that are equipped with bogies.

There are currently two types of biaxial bogies used in the field of railway technology, said types being namely such biaxial bogies in which each of the two axles is each equipped with a dedicated traction motor and such biaxial bogies that do not have a motor or a drive at all.

The object of the invention is to provide a bogie having improved characteristics in comparison to the prior art.

The object is achieved in accordance with the invention by means of a bogie having the features in accordance with the patent claim 1. Advantageous embodiments of the bogie in accordance with the invention are disclosed in subordinate claims.

Accordingly, it is provided in accordance with the invention that in the region of one of the track-guiding units, referred to hereinunder as the first track-guiding unit, a traction motor is provided that drives this first track-guiding unit, and in the region of another, non-driven track-guiding unit, referred to hereinunder as the second track-born unit, a converter is provided for supplying current to the traction motor that is driving the first track-guiding unit.

A significant advantage of the bogie in accordance with the invention relates to its asymmetrical construction or, in other words, to the fact that one track-guiding unit is driven and another track-guiding unit is not driven. This asymmetrical arrangement renders it possible to distribute the traction power over a rail-borne vehicle, in particular over a train of railcars, in a more uniform manner than in the case of conventional bogies, as a consequence of which the starting acceleration and the braking acceleration can be improved in all weather conditions.

A further essential advantage of the bogie in accordance with the invention resides in the fact that the installation space that is required in the case of bi-axially driven bogies for one of the two traction motors and in the case of the bogie in accordance with the invention is not required for a further traction motor can be used for the installation of the current convertor (or traction current convertor) for the remaining traction motor.

In addition, it is advantageous in the case of the bogie in accordance with the invention that said bogie forms an autonomous unit as a result of the current convertor being arranged on the bogie in a manner in accordance with the invention. This autonomous unit renders it possible to mount the bogie on the railcar bodies rapidly or to dismount the bogie from the railcar bodies rapidly since a connecting site for connecting the current convertor requires relatively little expenditure with regard to the cabling.

A further significant advantage of the bogie in accordance with the invention resides in the fact that both the weight and production costs are reduced since—as mentioned—the cabling expenditure is reduced in comparison to conventional bogies.

A further essential advantage of the bogie in accordance with the invention resides in the fact that it is possible using current convertors provided in the individual bogies to create a uniform connecting site for supplying energy and by way of said connecting site it is possible to route for example an intermediate circuit voltage through the entire rail-borne vehicle or the entire train of railcars. This state creates in an advantageous manner standardization options and renders possible as a consequence economies of scale in the area of procurement and also advantages as a result of fewer different replacement parts being required.

It is regarded as being particularly advantageous if the axis of rotation of the bogie divides the bogie—when viewed in the longitudinal direction of the bogie—into a front and a rear section, and the traction motor and the current convertor are arranged in different sections. The axis of rotation of the bogie can be formed by way of example by means of a swivel pin or a swivel pin receiving arrangement of the bogie.

It is preferred that the bogie comprises precisely two track-guiding units, namely the mentioned first driven track-guiding unit and the mentioned second, non-driven track-guiding unit.

The track-guiding units are preferably axle-based track-guiding units and it is accordingly regarded as being advantageous if the track-guiding units each comprise an axle and two wheels and the traction unit drives the axle of the first track-guiding unit.

It is preferred that the bogie comprises two axles, of which one is equipped with a block brake and the other is equipped with a wheel disc brake.

It is possible to provide as an alternative that both axles are equipped in each case with a block brake or in each case with a wheel disc brake.

The bogie is preferably an externally-mounted bogie, in other words a bogie where the wheels are located between the axle bearings that support the axles.

It is possible to provide as an alternative that the bogie is internally mounted bogie, in other words a bogie where the axle bearing is located between the wheels.

The invention relates in addition to a rail-borne vehicle, in particular a railway train. In accordance with the invention, it is provided with respect to such a rail-borne vehicle that said rail-borne vehicle is equipped with at least one bogie as is described above.

With regard to the advantages of the rail-borne vehicle in accordance with the invention, reference is made to the above statements in connection with the bogie in accordance with the invention.

In the case of the rail-borne vehicle, this can be by way of example an individual railcar train having at least two individual railcars. In the case of such an embodiment, it is regarded as being advantageous if the bogies of the individual railcars are embodied either with a traction motor and current convertor or are not provided with a drive—as described above.

It is particularly advantageous if all bogies of all individual railcars of the individual railcar train are each equipped with a traction motor and current convertor—as described above.

The rail-borne vehicle can be as an alternative an articulated train in which at least two railcar bodies are supported on the same bogie. In the case of such an embodiment, it is regarded as being advantageous if at least one of the bogies is equipped with a traction motor and a current convertor, as described above.

It is advantageous if all bogies of the articulated train are equipped in each case with a current convertor and a traction motor.

The invention is further explained hereinunder with reference to exemplary embodiments; in the drawings by way of example:

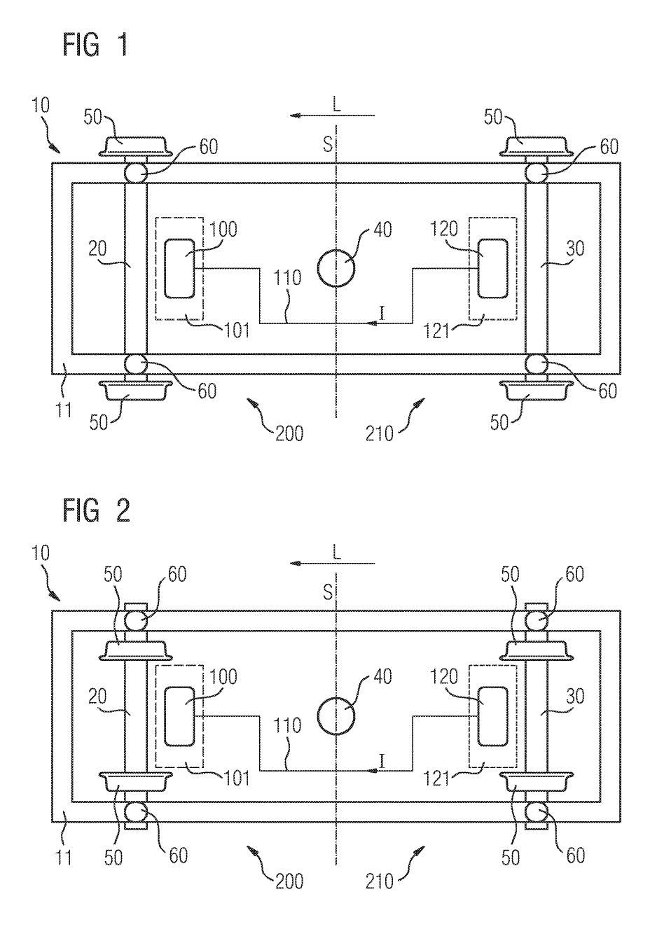

FIG. 1 illustrates an exemplary embodiment for an internally mounted bogie in accordance with the invention,

FIG. 2 illustrates an exemplary embodiment for an externally mounted bogie in accordance with the invention,

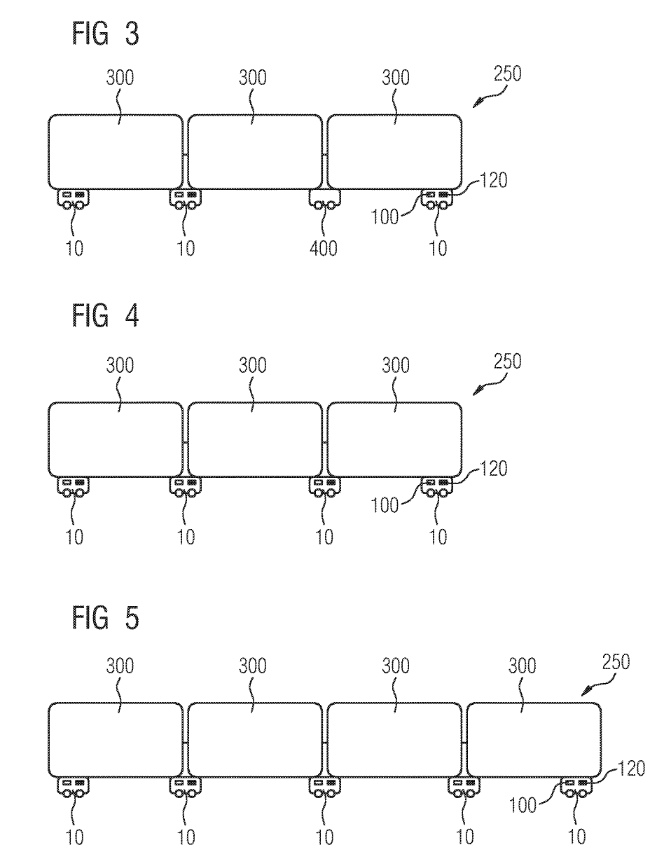

FIG. 3 illustrates an exemplary embodiment for a rail-borne vehicle in accordance with the invention in the form of a three-part articulated train,

FIG. 4 illustrates a further exemplary embodiment for a rail-borne vehicle in accordance with the invention in the form of a three-part articulated train,

FIG. 5 illustrates an exemplary embodiment for a rail-borne vehicle in accordance with the invention in the form of a four-part articulated train,

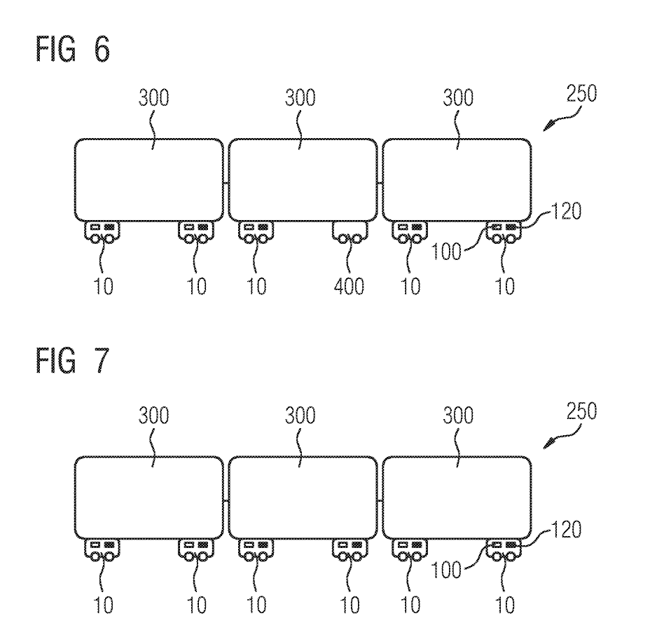

FIG. 6 illustrates as exemplary embodiment for a rail-borne vehicle in accordance with the invention in the form of a three-part individual railcar train and

FIG. 7 illustrates a further exemplary embodiment for a rail-borne vehicle in accordance with the invention in the form of a three-part individual railcar train.

For the sake of clarity, the same reference numerals are always used in the figures for identical or comparable components.

FIG. 1 illustrates an internally-mounted bogie 10 that comprises a first axle 20 and a second axle 30. The bogie 10 can rotate or pivot about an axis of rotation 40 that can be formed by means of a swivel pin that is attached to the bogie frame 11 of the bogie 10 or by means of a swivel pin receiving arrangement.

In each case, two wheels 50 are attached to each of the two axles 20 and 30; the axle bearings 60 that guide or support the respective axles on the bogie frame 11 are located between the wheels 50 of each axle.

The two axles 20 and 30 are also equipped with brakes that for reasons of clarity are not illustrated in FIG. 1. The brakes are preferably block brakes or wheel disc brakes. Depending upon the design of the bogie 10, the two axles 20 and 30 can be equipped in each case with block brakes and in each case wheel disc brakes; it is also possible to equip one of two axles with a block brake and the other of the two axles with a wheel disc brake.

The bogie 10 is equipped with a traction motor 100 that drives one of the two axles, in this case by way of example the first axle 20. The current supply to the traction motor 100 is provided by way of a current line 110 that connects the traction motor 100 to a current convertor 120. The current convertor 120 is arranged spatially in the region of the second axle 30 and is used to generate a traction current I that is supplied to the traction motor 100 by way of the current line 110.

When viewed in the longitudinal direction L of the bogie 10, the axis of rotation 40 divides the bogie 10 into a front section 200 and a rear section 210. The traction motor 100 and the current convertor 120 are arranged in different sections: in the case of the exemplary embodiment in accordance with FIG. 1, the traction motor 100 is located in the front section 200 and the current converter 120 is located in the rear section 210; alternatively the traction motor 100 and the current converter 120 can also be allocated in a converse manner, in other words the traction motor 100 can be located in the rear section 210 and the current convertor 120 can be arranged in the front section 200. Irrespective of whether the traction motor 100 is located in the front section 200 or in the rear section 210, it is advantageous if—as illustrated in FIG. 1—the traction motor 100 and the current convertor 120 are located in different sections or are arranged in the region of different axles 20 or 30 of the bogie. It is possible as a result of arranging the traction motor 100 in a different section to the current convertor 120 to also describe the bogie 10 in accordance with FIG. 1 as an asymmetrical bogie.

As a result of arranging the two components in different sections of the bogie 10, the current line 110 that connects the traction motor 100 and the current convertor 120 passes a virtual separation line S that is defined by the axis of rotation 40 and is located between the sections 200 and 210 of the bogie 10.

The bogie 10 comprises two receiving regions so as to receive the traction motor 100 and the current convertor 120 and said receiving regions are described in FIG. 1 by the reference numerals 101 and 121.

The two receiving regions 101 and 121 are preferably dimensioned and arranged in such a manner that the traction motor 100 could be mounted alternatively in the receiving region 121, in other words in the proximity of the second axle 30, and the current convertor 120 could be mounted alternatively in the receiving region 101, in other words in the proximity of the first axle 20.

It is particularly preferred that the receiving region 101 in which the traction motor 100 is located in the proximity of the first axle 20—with regard to the axis of rotation 40 of the bogie 10—is arranged in a rotationally symmetrical manner with respect to the particular receiving region 121 in which the current converter 120 is located in the region of the second axle 30. In other words, it is regarded as being advantageous if the current convertor 120 is located in the region of the second axle 30 in the section that is close to the axis and in which the traction motor 100 is located with regard to the first axle 20.

FIG. 2 illustrates an exemplary embodiment for an externally mounted bogie 10. The bogie 10 comprises a first axle 20 and also a second axle 30, that are provided in each case with two wheels 50. In contrast to the exemplary embodiment in accordance with FIG. 1, the axle bearings 60 for supporting the respective axle are located externally—with regard to the wheels 50.

The bogie 10 in accordance with FIG. 2 is also equipped with a traction motor 100 that is connected by way of a current line 110 to a current converter 120. The current convertor 120 is used to generate a traction current I that is supplied by way of the current line 110 into the traction motor 100.

The traction motor 100 is located in the case of the exemplary embodiment in accordance with FIG. 2 in the front section 200 of the bogie 10. The current convertor 120 is arranged in the region of the second axle 30 and thus in the region of the rear section 210 of the bogie. The two sections 200 and 210 of the bogie are separated from one another by means of the axis of rotation 40 that defines a virtual separation line S between the sections 200 and 210 of the bogie 10.

To summarize, it is common in the two bogies 10 in accordance with FIGS. 1 and 2 that in each case one of the two axles, in this case by way of example the first axle 20, is driven by means of a traction motor 100, whereas the other (in this case by way of example the second) axle 30 does not have a motor or a drive.

The FIG. 3 illustrates an exemplary embodiment for a rail-borne vehicle 250 in the form of a three-part articulated train.

The rail-borne vehicle 250 comprises three railcar bodies 300 that share a common bogie in each case with another railcar body. The rail-borne vehicle 250 that is equipped with three railcar bodies 300 in accordance with FIG. 3 thus manages with four bogies of which in the case of the exemplary embodiment in accordance with FIG. 3 three bogies 10 are equipped in each case with a traction motor 100 and a current convertor 120.

The traction motors 100 of the bogie 10 are located spatially in each case in the region of one of the axles of the respective bogie 10, and the current convertors 120 of the bogie 10 are located in each case in the region of the other axle of the bogie 10. The bogie can thus be described as asymmetrical with respect to its construction, at least with respect to the arrangement of the current convertor 120 and the traction motor 100.

One of the bogies, namely the bogie that is described in FIG. 3 by the reference numeral 400, does not have a drive or a motor.

FIG. 4 illustrates an exemplary embodiment for a rail-borne vehicle 10 in the form of a three-part articulated train in which all the bogies 10, as described in connection with FIGS. 1 and 2, are each embodied in an asymmetrical manner and are equipped with a traction motor 100 and a current convertor 120.

FIG. 5 illustrates an exemplary embodiment for a rail-borne vehicle 250 in the form of a four-part articulated train. Each of the railcar bodies 300 of the rail-borne vehicle 250 share in each case with another railcar body at least one common bogie 10.

In the case of the exemplary embodiment in accordance with FIG. 5, all the bogies 10 are equipped in each case with a traction motor 100 and a current convertor 120. In the case of the bogies 10 in accordance with FIG. 5, said bogies can be by way of example bogies as are described above by way of example in connection with the FIGS. 1 and 2.

FIG. 6 illustrates an exemplary embodiment for a rail-borne vehicle 250 in the form of a three-part individual railcar train. Each of the railcar bodies 300 is equipped in each case with two dedicated bogies.

In the case of the exemplary embodiment in accordance with FIG. 6, all the bogies except for one comprise in each case a traction motor 100 and a current convertor 120 that are arranged in different sections of the respective bogie. The bogies that comprise a traction motor 100 and a current convertor 120 are described in FIG. 6 by the reference numeral 10.

In addition, the rail-borne vehicle 250 in accordance with FIG. 6 comprises a bogie that does not have a motor and that is described by the reference number 400.

FIG. 7 illustrates a rail-borne vehicle 250 in the form of a three-part individual railcar train in which each railcar body 300 is supported on two dedicated bogies. All the bogies of the rail-borne vehicle 250 in accordance with FIG. 7 are in each case equipped with a traction motor 100 and a current convertor 120 that are arranged in different sections of the respective bogie 10. The bogies 10 in accordance with FIG. 7 can thus be equipped as is explained above by way of example in connection with FIGS. 1 and 2.

Although the invention is further illustrated and described in detail by means of the preferred exemplary embodiments, the invention is not limited by the disclosed examples and other variations can be derived therefrom by the person skilled in the art without departing from the protective scope of the invention.

1-14. (canceled)

15. A bogie for a rail-borne vehicle, the bogie comprising:
at least two track-guiding units including a first track-guiding unit, being a driven track-guiding unit, and a second track-guiding unit, being a non-driven track-guiding unit;
a traction motor for driving said first track-guiding unit disposed at said first track-guiding unit;
a current convertor for supplying current to said traction motor, said current converter being disposed at said second track-guiding unit.

16. The bogie according to claim 15, wherein said track-guiding units are wheel sets.

17. The bogie according to claim 15, wherein an axis of rotation of the bogie divides the bogie, viewed in a longitudinal direction thereof, into a front section and a rear section, and wherein said traction motor and said current convertor are arranged in mutually different said sections.

18. The bogie according to claim 15, wherein said track-guiding units are precisely two track-guiding units consisting of said first, driven track-guiding unit and said second, non-driven track-guiding unit.

19. The bogie according to claim 15, wherein each of said track-guiding units comprises an axle and two wheels, and said traction motor is configured to drive said axle of said first track-guiding unit.

20. The bogie according to claim 15, which comprises two axles, including a first axle equipped with a block brake and a second axle equipped with a wheel disc brake.

21. The bogie according to claim 15, which comprises two axles each equipped with a respective block brake.

22. The bogie according to claim 15, wherein the bogie comprises two axles and both axles are equipped with a wheel disc brake.

23. The bogie according to claim 15, which comprises a bogie frame and axles of said track-guiding units supporting said bogie frame, wherein said frame is supported on said axles to form an externally-mounted bogie.

24. The bogie according to claim 15, which comprises a bogie frame and axles of said track-guiding units supporting said bogie frame, wherein said frame is supported on said axles to form an internally-mounted bogie.

25. A rail-borne vehicle, comprising at least one bogie, the at least one bogie having:
at least two track-guiding units including a first track-guiding unit, being a driven track-guiding unit, and a second track-guiding unit, being a non-driven track-guiding unit;
a traction motor for driving said first track-guiding unit disposed at said first track-guiding unit;
a current convertor for supplying current to said traction motor, said current converter being disposed at said second track-guiding unit.

26. The rail-borne vehicle according to claim 25, wherein the rail-born vehicle is an individual railcar train having two or more individual railcars.

27. The rail-borne vehicle according to claim 26, wherein each of said individual railcars is equipped with at least one of said bogies.

28. The rail-borne vehicle according to claim 25, wherein the rail-borne vehicle is an articulated train in which at least two railcar bodies are supported on one common said bogie and said bogie is a bogie according to claim 15.

29. The rail-borne vehicle according to claim 28, wherein said articulated train are equipped with a plurality of bogies each being a bogie according to claim 15.
